(19) United States
(12) Patent Application Publication
(10) Pub. No.: US 2009/0029072 A1
(43) Pub. Date: Jan. 29, 2009

(54) Polyimide Resin Composition, Liquid Crystal Alignment Film using Same and Liquid Crystal Display using Such Liquid Crystal Alignment Film

(76) Inventors: Kenichiro Fujimoto, Hitachi (JP); Hiroyuki Kagawa, Hitachinaka (JP); Yuki Honda, Hitachi (JP)

Correspondence Address: FOLEY AND LARDNER LLP;SUITE 500, 3000 K STREET NW, WASHINGTON, DC, 20007, US

(21) Appl. No.: 11/664,987

(22) PCT Filed: Oct. 18, 2005
(86) PCT No.: PCT/JP2005/019073

§ 371 Date: Jul. 16, 2007

(30) Foreign Application Priority Data
Oct. 19, 2004 (JP) 2004-304365

(51) Int. Cl. C09K 19/02; B32B 27/00; C08G 69/26

(52) U.S. Cl. 428/1.26; 428/220; 528/347

(57) ABSTRACT

Disclosed is a polyimide resin composition which is composed of an acid dianhydride and a diamine compound and has a long-chain alkyl group in a side chain of the polyimide skeleton. The polyimide resin composition contains an aromatic component so that the weight ratio of the aromatic component relative to the total weight of the polyimide is not more than 20% (excluding 0%).

### TECHNICAL FIELD

The present invention relates to a polyimide resin composition, in more particularly, to a polyimide resin composition used for a liquid crystal alignment film.

### BACKGROUND ART

Polyimide resins have been conventionally used in various fields, since they have high mechanical strength, heat resistance, and solvent resistance. Among the polyimide resins, a lot of polyimide resins having aromatic ring have been studied by now, for the purpose of application to sealing material, printed circuit board or the like in the electric and electronic fields or the aviation and space fields, in which characteristics such as impact resistance, dimensional stability, abrasion resistance, heat resistance are required (For example, see patent documents 1 and 2).

On the other hand, as for a liquid crystal display unit used for a display device of various apparatus, liquid crystal alignment films are provided on each of opposed faces of substrates positioned opposite to each other, and polyimide resins having aromatic ring are often used as a component of such a liquid crystal alignment film (For example, see patent documents 3 and 4).

Characteristics required for the liquid crystal alignment film are various, and following characteristics are proposed as important properties:

(1) light resistance lifetime is long (high transparency); and

(2) an angle of a liquid crystal alignment film face with a longitudinal axis direction of a liquid crystal molecular group included in a liquid crystal composition composing a liquid crystal layer to be provided between substrates (hereinafter, referred as “pretilt angle”) is kept in a desired angle.

As a method for satisfying the aforementioned characteristic (2), there is a method of providing a pretilt angle in a polyimide main-chain skeleton (For example, see patent document 5) and a method of forming a liquid crystal alignment film of so-called side-chain type polyimide resin in that a long-chain alkyl group is introduced into a side-chain component as disclosed in patent document 4.

On the other hand, as a polyimide resin with high transparency, aliphatic system polyimide resins are known (For example, see patent documents 6, 7, and 8). In addition, there is a technique in which the transparency of a liquid crystal alignment film is increased (color fineness is improved) by defining a component composition of a liquid crystal alignment agent composing a liquid crystal alignment film (For example, see patent documents 9 and 10).

Patent document 1: Japanese Patent Laid-Open No. 60-6726

Patent document 2: Japanese Patent Laid-Open No. 2000-313804

Patent document 3: Japanese Patent No. 3097702

Patent document 4: Japanese Patent No. 3252564

Patent document 5: Japanese Patent Laid-Open No. 11-237638

Patent document 6: Japanese Patent Laid-Open No. 5-301958

Patent document 7: Japanese Patent Laid-Open No. 8-003314

Patent document 8: Japanese Patent Publication for opposition No. 6-48337

Patent document 9: Japanese Patent Laid-Open No. 2000-250047

Patent document 10: Japanese Patent Laid-Open No. 2001-42335

### DISCLOSURE OF INVENTION

### Problems to be Solved by the Invention

In a display device having a light source with a high optical output such as a liquid crystal projector, a high light resistance is required for a component (liquid crystal display unit) to be used in the liquid crystal display. The term “light resistance” here is a characteristic representing a degradation degree with respect to the light, and defectiveness will easily occur in the liquid crystal display if the light resistance is bad. Therefore, it is planned to improve the light resistance by increasing the transparency in order to prevent this phenomenon.

In this regard, the high transparency (good light resistance) can be obtained by forming the liquid crystal display using the polyimide resin that is synthesized by introducing a long-chain alkyl into a side-chain of an aliphatic system polyimide resin. However, in this case, a large pretilt angle, for example, more than 3° cannot be obtained as a desired angle. It is assumed that this phenomenon is caused since a film composed of any aliphatic system polyimide resin is weak in liquid crystal alignment regulating force.

As described above, in the conventional liquid crystal alignment films, although either a large pretilt angle characteristic or a high transparency characteristic can be satisfied, both of these characteristics cannot be satisfied simultaneously.

In consideration of the aforementioned circumstances, an object of the present invention is to provide a polyimide resin composition with a good light resistance by which a large pretilt angle can be provided, to provide a liquid crystal alignment film using same, and to provide a liquid crystal display using such liquid crystal alignment film.

### Means for Solving the Problems

For achieving the above object, a polyimide resin composition according to the present invention comprises an acid dianhydride and a diamine compound, which includes a long-chain alkyl group in a side-chain in its polyimide skeleton, and includes an aromatic component such that a weight ratio of the aromatic component relative to a total weight of a polyimide is not more than 20% (excluding 0%).

The diamine compound preferably includes a long-chain alkyl group in a side-chain and the acid dianhydride is preferably an aliphatic system acid dianhydride. In addition, it is preferable that the diamine compound includes an aromatic diamine compound and an aliphatic diamine compound, and at least one of the aromatic diamine compound and the aliphatic diamine compound includes a long-chain alkyl group in a side-chain. Further, it is preferable that a mol fraction of the aromatic diamine compound is not less than a mol fraction of the diamine compound including the long-chain alkyl group in the side-chain. Still further, it is preferable that the diamine compound including the long-chain alkyl group in the side-chain is an aliphatic diamine compound.

In addition, a polyimide resin composition according to the present invention comprises an acid dianhydride and a diamine compound, which has repeating units represented by the formula (1) and includes an aromatic component such that a weight ratio of the aromatic component relative to a total weight of a polyimide is not more than 20% (excluding 0%):

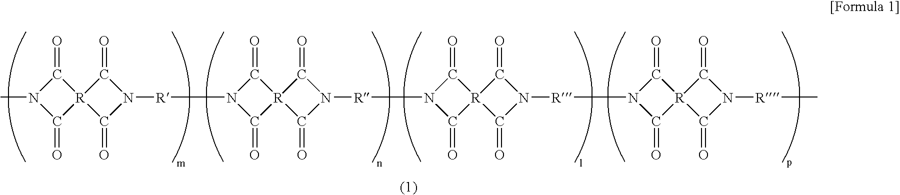

(wherein R represents a tetravalent aliphatic group, and R′, R″, R′″, and R″″ are a divalent long-chain alkyl group non-containing aromatic group, a long-chain alkyl group non-containing aliphatic group, a long-chain alkyl group containing aromatic group, and a long-chain alkyl group containing aliphatic group, respectively. m, n, l, and p represent copolymerization ratios in the polyimide resin, respectively, wherein relationships m+n+l+p=1 and m≧0, n≧0, l≧0, p≧0, m+l>0, n+p>0, and l+p>0 are established).

It is preferable that a mol fraction of the aromatic diamine compound is not less than a mol fraction of a long-chain alkyl group containing diamine in the diamine compound constituting the formula (1). Further, it is preferable that the long-chain alkyl group containing diamine is an aliphatic diamine compound.

In addition, it is preferable that the polyimide resin composition has a light transmission rate of not less than 80% with respect to a light having a wavelength of 400 to 800 nm in a film composed of the polyimide resin composition and having a film thickness of 1 μm.

On one hand, a liquid crystal alignment film according to the invention comprises the aforementioned polyimide resin composition formed to have a film-shape.

On the other hand, according to the invention, a liquid crystal display unit comprises:

a pair of substrates, at least one of the substrates being transparent;

the liquid crystal alignment films, each of which being formed on opposite faces of the pair of substrates and having the light transmission rate; and

a liquid crystal composition disposed between the liquid crystal alignment films;

wherein a liquid crystal molecular group included in the liquid crystal composition has a pretilt angle of not less than 3°.

This application is based on Japanese patent application No. 2004-304365, and all content of this Japanese application is introduced herein by reference.

### EFFECTS OF INVENTION

By using a polyimide resin composition according to the present invention, it is possible to manufacture a liquid crystal display which satisfies a good light resistance and a large pretilt angle simultaneously.

In addition, this liquid crystal display unit has an excellent liquid crystal alignment property.

### BRIEF DESCRIPTION OF DRAWINGS

FIG. 1 is a cross sectional view of a liquid crystal display unit in a preferred embodiment according to the present invention; and

FIG. 2 is a diagram showing a state for conducting a rubbing process on a liquid crystal alignment film which is one component of the liquid crystal display unit in FIG. 1.

### BEST MODE FOR CARRYING OUT THE INVENTION

Next, a preferred embodiment according to the present invention will be explained below in conjunction with the appended drawings.

A polyimide resin composition in the preferred embodiment is composed of an acid dianhydride and a diamine compound, which includes a long-chain alkyl group as a side-chain alkyl group of its polyimide skeleton, and comprises an aromatic component such that a weight ratio of the aromatic component relative to a total weight of the polyimide is not more than 20% (excluding 0%). The term “a weight ratio of an aromatic component” here is a value of a molecular weight of aromatic ring in the polyimide resin composition (excluding a molecular weight of organic group connected to the aromatic ring) divided by a molecular weight of the total polyimide resin composition. In addition, the term “side-chain alkyl group” here is an alkyl group coupled to a polyimide main-chain skeleton.

It is preferable that the side-chain alkyl group in the polyimide resin composition is a diamine compound including a long-chain alkyl group.

A preferable polyimide resin composition is a polymer which comprises an acid dianhydride and a diamine compound and has repeating units represented by following chemical formula (1).

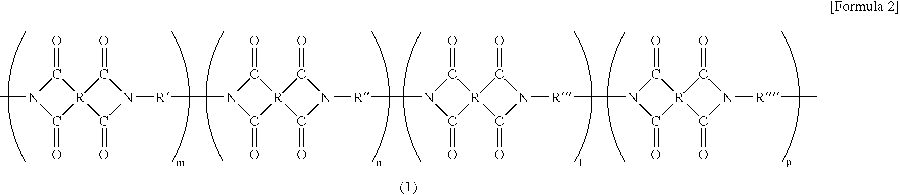

(in the formula, R is a tetravalent aliphatic group, and R′, R″, R′″, and R″″ are a divalent long-chain alkyl group non-containing aromatic group, a long-chain alkyl group non-containing aliphatic group, a long-chain alkyl group containing aromatic group, and a long-chain alkyl group containing aliphatic group, respectively. In addition, m, n, l, and p represent copolymerization ratios in the polyimide resin, respectively, wherein relationships m+n+l+p=1 and m≧0, n≧0, l≧0, p≧0, m+l>0, n+p>0, and l+p>0 are established).

Parts expressed by R′, R″, R″′, and R″″ in the chemical formula (1) are diamine compounds, and other parts are acid dianhydrides. In addition, the tetravalent aliphatic group (R) in the chemical formula (1) may be chain-shaped or ring-shaped.

Next, operative examples of the acid dianhydride and the diamine compound composing the polyimide resin composition in the preferred embodiment will be explained in more detail.

(Acid Dianhydride)

As the acid dianhydride composing the polyimide resin composition, for example, aliphatic tetracarboxylic acid dianhydride, and aromatic tetracarboxylic acid dianhydride may be used.

(Aliphatic Tetracarboxylic Acid Dianhydride)

As the aliphatic tetracarboxylic acid dianhydride, for example, butane tetracarboxylic acid dianhydride, 1,2,3,4-cyclobutane tetracarboxylic acid dianhydride, 1,2-dimethyl-1,2,3,4-cyclobutane tetracarboxylic acid dianhydride, 1,3-dimethyl-1,2,3,4-cyclobutane tetracarboxylic acid dianhydride, 1,2,3,4-cyclopentane tetracarboxylic acid dianhydride, 1,2,4,5-cyclohexane tetracarboxylic acid dianhydride, 2,3,5-tricarboxycyclopentyl acetic acid dianhydride, 3,5,6-tricarboxy norbornane-2-acetic acid dianhydride, 2,3,4,5-tetrahydrofuran tetracarboxylic acid dianhydride, 3,3′,4,4-dicyclohexyl tetracarboxylic acid dianhydride, and bicyclo[2,2,2]-octo-7-ene-2,3,5,6-tetracarboxylic acid dianhydride may be used. However, the present invention is not limited thereto.

(Aromatic Tetracarboxylic Acid Dianhydride)

As the aromatic tetracarboxylic acid dianhydride, for example, pyromellitic acid dianhydride, 3,3′,4,4′-biphenyl sulfone tetracarboxylic acid dianhydride, 3,3′,4,4′-benzophenone tetracarboxylic acid dianhydride, 1,4,5,8-naphtalene tetracarboxylic acid dianhydride, 2,3,6,7-naphtalene tetracarboxylic acid dianhydride, 3,3′,4,4′-biphenyl ether tetracarboxylic acid dianhydride, 3,3,4,4′-dimethyl diphenyl silane tetracarboxylic acid dianhydride may be used, however, the present is not limited thereto. These acid dianhydrides may be used alone or as a combination of more than two kinds.

(Diamine Compound)

As the diamine compound composing the polyimide resin composition, for example, aliphatic system diamine, and aromatic system diamine may be used. A preferable diamine compound includes both aromatic system diamine compound and aliphatic system diamine compound, and at least one of these diamine compounds includes a long-chain alkyl group.

(Aliphatic System Diamine Compound)

As the aliphatic system diamine compound, for example, alicyclic diamine compound such as 1,3-bis(aminomethyl)cyclohexane, 1,2-cyclohexane diamine, 1,3-cyclohexane diamine, 3,3′-dimethyl-4,4′-diamino-dicyclohexylmethane, 3,9-bis(3-aminopropyl)-2,4,8,10-tetraoxaspiro-(5,5)undecane, 4,4′-diaminodicyclohexylmethane, 1,4-bis(3-aminopropyl)piperazine, and aliphatic diamine such as hexamethylene diamine, 1,2-diaminotetradecane, 1,2-diaminoheptadecane, 1,2-diaminooctadecane, 1,9-diaminononane, 2,2-dimethyl-1,3-propane diamine, 1,11-diaminoundecane, aminopropyl terminal dimethyl silicone (Low M.W.), aminopropyl terminal dimethyl silicone (High M.W.) may be used, however, the present invention is not limited thereto. These aliphatic system diamine compounds may be used alone or as a combination of more than two kinds.

(Aromatic System Diamine Compound)

In addition, the aromatic system diamine compound is included such that a weight ratio of the aromatic component is not more than 20% (excluding 0%), preferably from 3 to 15%, and more preferably from 5 to 10%. When the weight ratio of the aromatic component exceeds 20%, the transparency turns worse and the light transmission rate is deteriorated.

As the aromatic system diamine compound, for example, p-phenylene diamine, p-xylene diamine, 3,3′-dimethyl-4,4′-diaminobiphenyl, 2,2′-dimethyl-4,4′-diaminobiphenyl, 2,2′-bis(trifluoromethyl)-4,4′-diaminobiphenyl, 4,4′-diaminodiphenyl ether, 3,4′-diaminodiphenyl ether, 1,3-bis-(4-aminophenoxy)benzene, 1,3-bis-(3-aminophenoxy)benzene, 4,4′-diaminodiphenylsulfone, bis{4-(3-aminophenoxy)phenyl}sulfone, 2,2′-bis{4-(4-aminophenoxy)phenyl}propane, 2-dodecyloxy-1,4-diaminobenzene, 2,2′-bis{4-(4-aminophenoxy)phenyl}hexafluoropropane, 4,4′-diaminobenzanilide, isophthalate dihydrazide, 3,5-diaminobenzoic acid may be used, however, the present invention is not limited thereto. These aromatic system diamine compounds may be used alone or as a combination of more than two kinds.

(Manufacturing Method of Polyimide)

The polyimide resin composition in the preferred embodiment can be obtained by dissolving the tetracarboxylic acid dianhydride and the diamine compound at a predetermined mixing ratio in an organic solvent, and thereafter directly imidizing it.

It is sufficient if the mixing ratio of the diamine compound is substantially the same as the tetracarboxylic acid dianhydride, and more preferably 1:1.

The imidization can be conducted under heat or at a presence of an imidizing catalyst. A reaction temperature for imidization under heat is preferably from 80° C. to 200° C., and more preferably from 120° C. to 180° C.

As the organic solvent, although the present invention is not limited thereto, N-methyl-2-pyrolidone, dimethylformamido, dimethylacetamido, sulfolane, anisole, dioxolan, butyl cellosolve acetate, lactonic system or the like may be used. These organic solvents may be used alone or as a combination of more than two kinds. In general, it is preferable that a dosage of the organic solvent is determined such that a total weight of the tetracarboxylic acid dianhydride and the diamine compound relative to a total weight of a reaction solution is from 5 to 40 weight %.

A polyimide solution thus obtained is poured into a poor solvent, such as aqua, alcohols, ketones, ethers, esters, halogenated hydrocarbons, hydrocarbons to be crystallized as a polymer. As the poor solvent, for example, methanol, ethanol, isopropyl alcohol, cyclohexanol, 1,4-butanediol, acetone, methyl ethyl ketone, methyl isobutyl ketone, cyclohexanone, methyl acetate, ethyl acetate, diethyl malonate, diethyl ether, methyl cellosolve, ethyl cellosolve, butyl cellosolve, tetrahydrofuran, dichloromethane, hexane, heptane, octane, benzene, toluene, xylene or the like may be used.

It is possible to obtain a desired polyimide resin powder by drying a polymer powder thus obtained under evacuation. It is preferable that a drying temperature is determined in consideration with a boiling point of the poor solvent used in the aforementioned process.

(Liquid Crystal Alignment Film)

A liquid crystal alignment film can be provided by forming a film using the polyimide resin composition in the preferred embodiment.

A film thickness of the film may be thinner than (or thicker than) 1 μm, if the film is composed of a polyimide resin composition which has a light transmission rate of not less than 80% with respect to a light having a wavelength of 400 to 800 nm when the film thickness is 1 μm.

(Liquid Crystal Display Unit)

A liquid crystal display unit (cell) can be provided by using the liquid crystal alignment film composed of the polyimide resin composition in the preferred embodiment.

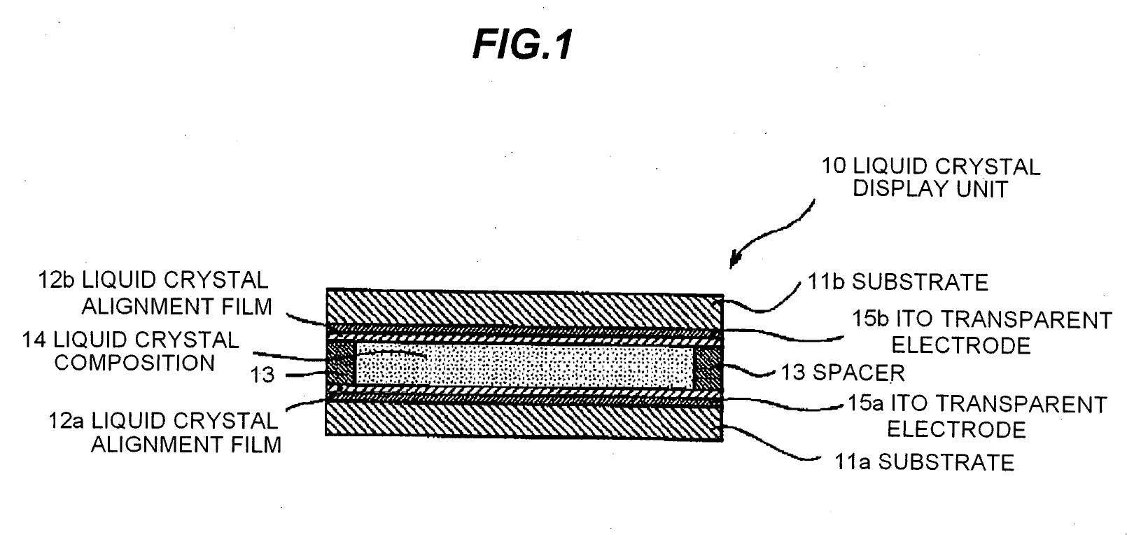

As shown in FIG. 1, a liquid crystal display unit 10 is provided by forming ITO (Indium-Tin-Oxide) transparent electrodes 15a, 15b on certain surfaces (an upper surface of a substrate 11a, a lower surface of a substrate 11b in FIG. 1) of a pair of the substrates 11a, 11b, at least one of which is transparent, successively forming liquid crystal alignment films 12a, 12b composed of the polyimide resin composition in the preferred embodiment thereon, disposing the substrates 11a, 11b to be adjacent to and opposed to each other via spacers 13,13 in a state where forming surfaces of the respective liquid crystal alignment films 12a, 12b are facing to each other, and sealing a liquid crystal composition 14 in a space surrounded by the substrates 11a, 11b (the liquid crystal alignment films 12a, 12b) and the spacers 13, 13.

A pretilt angle of a liquid crystal alignment film surface with a longitudinal axis direction of a liquid crystal molecular group included in the liquid crystal composition 14 may be arbitrarily set, if the pretilt angle is large enough, e.g. not less than 3°, and within a predetermined range (in concrete, a range of 3 to 15°, and preferably a range of 5 to 10°). The pretilt angle can be adjusted freely by adjusting a content of the long-chain alkyl group component.

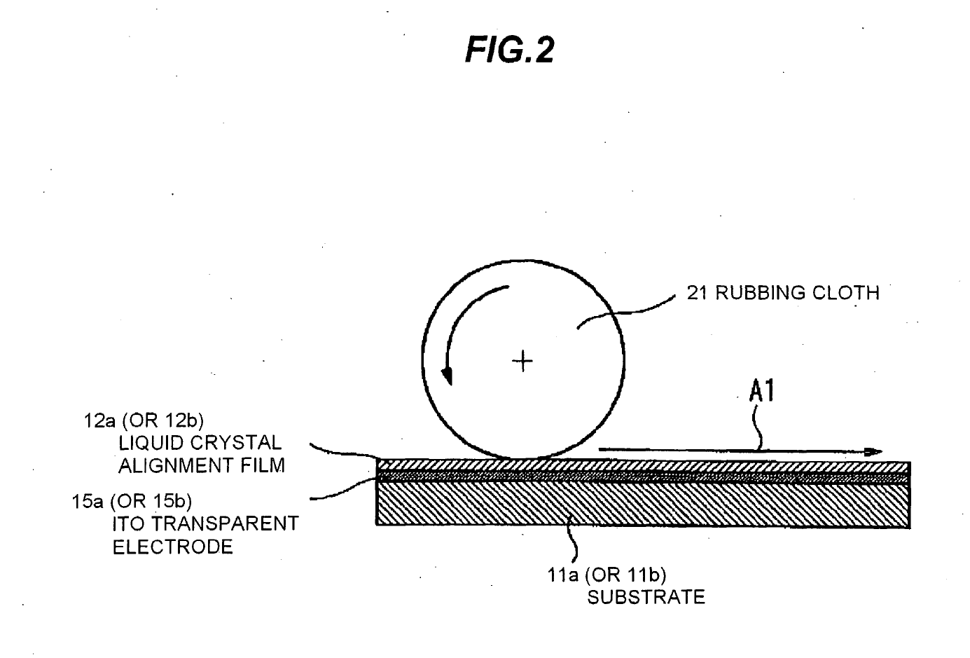

As shown in FIG. 2, the liquid crystal alignment films 12a, 12b are subject to the rubbing process (rubbed) in one direction (a direction indicated by an arrow A1 in FIG. 2) by using a rubbing cloth 21. By this process, the liquid crystal alignment film 12a (or 12b) is provided with the alignment property.

In the liquid crystal display unit 10 as shown in FIG. 1, the liquid crystal alignment films 12a, 12b are disposed to be facing to each other such that rubbing directions thereof are perpendicular to each other to manufacture a liquid crystal cell.

The substrates 11a, 11b are not limited to particular substrates and any substrate which is conventionally used as a substrate for a liquid crystal display unit may be applied.

As to regard FIGS. 1 and 2, the explanation is made for a case where the ITO transparent electrodes 15a, 15b are uniformly formed in sheet-shape (layer-shape). However, in an actual product (liquid crystal display unit), patterning is conducted on the ITO transparent electrodes formed in the sheet-shape to form a pattern of the ITO transparent electrode.

(Manufacturing Method of Liquid Crystal Display Unit)

The liquid crystal display unit in the preferred embodiment may be manufactured, for example, by a following method.

At first, a liquid crystal alignment agent having a solid concentration of 3 weight % is applied by spin coat method on a glass substrate 11a (11b) provided with an ITO (Indium-Tin-Oxide) transparent electrode 15a (15b), thereafter dried at a temperature of 80° C. for temporary desiccation, and dried at a temperature of 250° C. to provide a uniform liquid crystal alignment film 12a (12b).

Next, the rubbing process for rubbing this coating film in one direction is conducted by using a roll on which fibers such as rayon, cotton or the like are wound. The two substrates 11a (11b) with the two liquid crystal alignment films 12a (12b) formed by the aforementioned process are disposed to be opposed to each other via a gap between the two substrates 11a (11b) such that rubbing directions thereof are perpendicular to each other, and a periphery of the two substrates 11a (11b) are adhered to each other by a sealing agent.

Furthermore, the two substrates 11a(11b) are sealed by injecting a liquid crystal composition 14 into the gap therebetween to provide a liquid crystal display 10.

### EFFECT OF THE PREFERRED EMBODIMENT

A polyimide resin composition in the preferred embodiment comprises a polyimide skeleton which is composed of an acid dianhydride and a diamine compound, and the diamine compound includes a side-chain alkyl group in the polyimide skeleton and the side-chain alkyl group includes a long-chain alkyl group. The diamine compound (side-chain alkyl group) comprises an aromatic component such that a weight ratio of the aromatic component relative to a total weight of the polyimide is not more than 20% (excluding 0%).

It is possible to simultaneously satisfy two characteristics (large pretilt angle and high transparency (good light resistance)) that cannot be achieved in the conventional device, by manufacturing the liquid crystal alignment film and the liquid crystal display unit by using the polyimide resin composition having a composition configuration as described above in the preferred embodiment. In particular, as for the pretilt angle, it is possible to arbitrarily set a large pretilt angle of not less than 3° as a desired angle. Thus, an effect for reducing a display irregularity of the liquid crystal alignment film can be obtained, since the large pretilt angle of not less than 3° can be provided. In addition, since the high transparency is provided, the light resistance is improved (i.e. the light resistance lifetime is prolonged) so that durability of the liquid crystal display is improved (the lifetime is prolonged).

The liquid crystal display unit using the polyimide resin composition in the preferred embodiment is suitable for the liquid crystal display used as a display device of various information apparatuses, and in particular suitable for the display device having a light source with a high optical output such as the liquid crystal projector in which a high light resistance is required.

The present invention is not limited to the preferred embodiment as described above, and various kinds of embodiments may be assumed other than the preferred embodiment.

Next, the present invention will be explained based on examples, however, the present invention is not limited to these examples.

### Example 1

### Example 1

In a four-necked separable flask of 300 ml installed with a stirrer, an Allihn condenser comprising a trap with a silicone cock is installed. In the flask, 1,2,3,4-cyclopentane tetracarboxylic acid dianhydride (hereinafter, referred as “CPDA”) of 6.30 g,

4,4′-diaminodicyclohexylmethane (hereinafter, referred as “DAHM”) of 2.52 g,
p-xylene diamine (hereinafter, referred as “XyDA”) of 1.22 g, γ-caprolactone of 0.34 g,
2-dodecyloxy-1,4-diaminobenzene (hereinafter, referred as “DODB”) of 3.39 g,
pyridine of 0.47 g,

### NMP of 45.44 g, and

toluene of 20 g
are added respectively, and agitated at a room temperature in an atmosphere of nitrogen for 10 minutes. Thereafter, the temperature is raised up to 180° C., and agitated for about 10 hours, to provide a reaction liquid (varnish). In addition, aqua generated during the reaction is distilled away from a reaction system by azeotropy with a toluene.

Subsequently, the varnish thus obtained is poured into a methanol to produce a precipitation, and commination, filtration, cleaning and drying under reduced pressure are conducted for the precipitation to provide a polyimide powder.

### Example 2

In the flask similar to that in the Example 1,

### CPDA of 6.30 g,

1,3-bis(aminomethyl)cyclohexane (hereinafter, referred as “BACA”) of 1.70 g,
1,3-bis(3-aminophenoxy)benzene (hereinafter, referred as “APB”) of 2.62 g,
1,3-diaminopropane-2-dodecane (hereinafter, referred as “DPD” of 2.05 g,
γ-caprolactone of 0.46 g,
pyridine of 0.63 g,

### NMP of 65.36 g, and

toluene of 20 g
are added respectively, and the treatment similar to that in the Example 1 is conducted thereafter, to provide a polyimide powder.

### Example 3

In the flask similar to that in the Example 1,

### CPDA of 6.30 g,

3,3′-dimethyl-4,4′-diaminodicyclohexylmethane (hereinafter, referred as “DMHM”) of 2.86 g,
p-phenylene diamine (hereinafter, referred as “PPD”) of 0.97 g, 1,2-diaminoctadecane (hereinafter, referred as “DOD”) of 2.05 g, γ-caprolactone of 0.34 g,
pyridine of 0.47 g,

### NMP of 45.44 g, and

toluene of 20 g,
are added respectively, and the treatment similar to that in the Example 1 is conducted thereafter, to provide a polyimide powder.

### Example 4

In a flask similar to that in the Example 1,

### CPDA of 6.30 g,

### DAHM of 2.52 g,

isophthalate dihydrazide (hereinafter, referred as “IPDH”) of 2.33 g,

### DODB of 1.75 g,

γ-caprolactone of 0.34 g,
pyridine of 0.47 g,

### NMP of 45.44 g, and

toluene of 20 g,
are added respectively, and the treatment similar to that in the Example 1 is conducted thereafter, to provide a polyimide powder.

### Example 5

In a flask similar to that in the Example 1,

### CPDA of 6.30 g,

### DMHM of 2.86 g,

### IPDH of 2.33 g,

### DOD of 1.70 g,

γ-caprolactone of 0.34 g,
pyridine of 0.47 g,

### NMP of 45.44 g, and

toluene of 20 g,
are added respectively, and the treatment similar to that in the Example 1 is conducted thereafter, to provide a polyimide powder.

### Example 6

In a flask similar to that in the Example 1,

### CPDA of 6.30 g,

3,9-bis(3-aminopropyl)-2,4,8,10-tetraoxaspiro-(5,5)undecane (hereinafter, referred as “ATU”) of 3.29 g,

### XyDA of 1.22 g,

### DPD of 2.05 g,

γ-caprolactone of 0.34 g,
pyridine of 0.47 g,

### NMP of 45.44 g, and

toluene of 20 g
are added respectively, and the treatment similar to that in the Example 1 is conducted thereafter, to provide a polyimide powder.

### Example 7

In a flask similar to that in the Example 1,

### CPDA of 6.30 g,

### DMHM of 2.86 g,

### XyDA of 1.23 g,

### DOD of 2.63 g,

γ-caprolactone of 0.34 g,
pyridine of 0.47 g,

### NMP of 45.44 g, and

toluene of 20 g
are added respectively, and the treatment similar to that in the Example 1 is conducted thereafter, to provide a polyimide powder.

### Example 8

In a flask similar to that in the Example 1,

### CPDA of 6.30 g,

### DMHM of 2.86 g,

### APB of 2.63 g,

### DOD of 2.63 g,

γ-caprolactone of 0.34 g,
pyridine of 0.47 g,

### NMP of 45.44 g, and

toluene of 20 g
are added respectively, and the treatment similar to that in the Example 1 is conducted thereafter, to provide a polyimide powder.

### Example 9

In a flask similar to that in the Example 1,

### CPDA of 6.30 g,

1,2-cyclohexanediamine of 1.35 g,

### IPDH of 2.33 g,

### DODB of 1.75 g,

γ-caprolactone of 0.34 g,
pyridine of 0.47 g,

### NMP of 45.44 g, and

toluene of 20 g
are added respectively, and the treatment similar to that in the Example 1 is conducted thereafter, to provide a polyimide powder.

### Example 10

In a flask similar to that in the Example 1,

### CPDA of 6.30 g,

### DMHM of 5.01 g,

### DODB of 2.63 g,

γ-caprolactone of 0.34 g,
pyridine of 0.47 g,

### NMP of 53.36 g, and

toluene of 20 g
are added respectively, and the treatment similar to that in the Example 1 is conducted thereafter, to provide a polyimide powder.

### Example 11

In a flask similar to that in the Example 1,

### CPDA of 6.30 g,

### DMHM of 2.15 g,

### PPD of 1.30 g,

### DOD of 2.59 g,

γ-caprolactone of 0.34 g,
pyridine of 0.47 g,

### NMP of 45.04 g, and

toluene of 20 g,
are added respectively, and the treatment similar to that in the Example 1 is conducted thereafter, to provide a polyimide powder.

### Example 12

In a flask similar to that in the Example 1,

### CPDA of 6.30 g,

### ATU of 3.29 g,

### PPD of 0.65 g,

### DPD of 2.90 g,

γ-caprolactone of 0.34 g,
pyridine of 0.47 g,

### NMP of 50.44 g, and

toluene of 20 g
are added respectively, and the treatment similar to that in the Example 1 is conducted thereafter, to provide a polyimide powder.

### Example 13

In a flask similar to that in the Example 1,

### CPDA of 6.30 g,

### DMHM of 2.86 g,

### PPD of 0.97 g,

### DODB of 3.11 g,

γ-caprolactone of 0.34 g,
pyridine of 0.47 g,

### NMP of 48.64 g, and

toluene of 20 g,
are added respectively, and the treatment similar to that in the Example 1 is conducted thereafter, to provide a polyimide powder.

### Example 14

In a flask similar to that in the Example 1, 1,2,4,5-cyclohexane tetracarboxylic acid dianhydride of 3.36 g, DMHM of 1.43 g,

### PPD of 0.49 g,

### DOD of 1.29 g,

γ-caprolactone of 0.17 g,
pyridine of 0.24 g,

### NMP of 24.07 g, and

toluene of 4.81 g,
are added respectively, and the treatment similar to that in the Example 1 is conducted thereafter, to provide a polyimide powder.

### Example 15

In a flask similar to that in the Example 1, 1,2,4,5-cyclohexane tetracarboxylic acid dianhydride of 6.73 g, DMHM of 2.50 g,

### APB of 3.07 g,

### DOD of 2.56 g,

γ-caprolactone of 0.34 g,
pyridine of 0.47 g,

### NMP of 55.12 g, and

toluene of 20 g,
are added respectively, and the treatment similar to that in the Example 1 is conducted thereafter, to provide a polyimide powder.

### Example 16

In a flask similar to that in the Example 1,

### CPDA of 6.30 g,

### DMHM of 2.86 g,

### PPD of 0.97 g,

### DOD of 2.56 g,

γ-caprolactone of 0.34 g,
pyridine of 0.47 g,

### NMP of 45.44 g, and

toluene of 20 g,
are added respectively, and the treatment similar to that in the Example 1 is conducted thereafter, to provide a polyimide powder.

### Example 17

In a flask similar to that in the Example 1,

### CPDA of 8.41 g,

### DMHM of 4.77 g,

### IPDH of 2.33 g,

### DOD of 2.29 g,

γ-caprolactone of 0.46 g,
pyridine of 0.63 g,

### NMP of 65.36 g, and

toluene of 20 g,
are added respectively, and the treatment similar to that in the Example 1 is conducted thereafter, to provide a polyimide powder.

### Example 18

In a flask similar to that in the Example 1,

### CPDA of 6.30 g,

### DMHM of 2.86 g,

### PPD of 0.97 g,

### DODB of 3.11 g,

γ-caprolactone of 0.34 g,
pyridine of 0.47 g,

### NMP of 48.64 g, and

toluene of 20 g,
are added respectively, and the treatment similar to that in the Example 1 is conducted thereafter, to provide a polyimide powder.

### Example 19

In a flask similar to that in the Example 1,

### CPDA of 6.30 g,

### DMHM of 2.50 g,

### PPD of 0.97 g,

### DOD of 3.02 g,

γ-caprolactone of 0.34 g,
pyridine of 0.95 g,

### NMP of 46.68 g, and

toluene of 20 g,
are added respectively, and the treatment similar to that in the Example 1 is conducted thereafter, to provide a polyimide powder.

### Comparative Example 1

In a flask similar to that in the Example 1, 4,4′-oxydiphthalic acid dianhydride of 12.41 g, 3,5-diamino benzoic acid of 6.09 g,

γ-caprolactone of 0.46 g,
pyridine of 0.63 g,

### NMP of 68.24 g, and

toluene of 20 g
are added respectively, and the treatment similar to that in the Example 1 is conducted thereafter, to provide a polyimide powder.

### Comparative Example 2

In a flask similar to that in the Example 1,

### CPDA of 6.30 g,

### DMHM of 7.15 g,

γ-caprolactone of 0.34 g,
pyridine of 0.47 g,

### NMP of 49.48 g, and

toluene of 20 g
are added respectively, and the treatment similar to that in the Example 1 is conducted thereafter, to provide a polyimide powder.

### Comparative Example 3

In a flask similar to the Example 1,

### CPDA of 4.20 g,

### DMHM of 3.34 g,

### DOD of 1.71 g,

γ-caprolactone of 0.23 g,
pyridine of 0.32 g,

### NMP of 34.12 g, and

toluene of 15 g,
are added respectively, and the treatment similar to that in the Example 1 is conducted thereafter, to provide a polyimide powder.

### Comparative Example 4

In a flask similar to that in the Example 1,

### CPDA of 12.61 g,

pyromellitic acid dianhydride of 2.62 g,

### DMHM of 14.31 g,

2,2′-bis{4-(4-aminophenoxy)phenyl}hexafluoropropane of 6.22 g, γ-caprolactone of 0.68 g,
pyridine of 0.95 g,

### NMP of 99.04 g, and

toluene of 20 g
are added respectively, and the treatment similar to that in the Example 1 is conducted thereafter, to provide a polyimide powder.

### Comparative Example 5

In a flask similar to that in the Example 1,

pyromellitic acid dianhydride of 6.54 g,
4,4′-diaminodiphenylsulfone of 0.74 g,

### DMHM of 6.44 g,

γ-caprolactone of 0.34 g,
pyridine of 0.47 g,

### NMP of 50.56 g, and

toluene of 20 g
are added respectively, and the treatment similar to that in the Example 1 is conducted thereafter, to provide a polyimide powder.

### Comparative Example 6

In a flask similar to that in the Example 1, 1,2,4,5-cyclohexane tetracarboxylic acid dianhydride of 8.41 g, DAHM of 2.52 g,

### APB of 4.68 g,

### DODB of 3.50 g,

γ-caprolactone of 0.46 g,
pyridine of 0.63 g,

### NMP of 74.76 g, and

toluene of 15 g
are added respectively, and the treatment similar to that in the Example 1 is conducted thereafter, to provide a polyimide powder.

### Comparative Example 7

In a flask similar to that in the Example 1, 1,2,4,5-cyclohexane tetracarboxylic acid dianhydride of 8.41 g, DAHM of 2.52 g,

### APB of 4.68 g,

### DODB of 5.26 g,

γ-caprolactone of 0.46 g,
pyridine of 0.63 g,

### NMP of 74.76 g, and

toluene of 20 g,
are added respectively, and the treatment similar to that in the Example 1 is conducted thereafter, to provide a polyimide powder.

### Comparative Example 8

In a flask similar to that in the Example 1,

### CPDA of 6.30 g,

### DMHM of 2.50 g,

### APB of 2.63 g,

### DODB of 3.07 g,

γ-caprolactone of 0.34 g,
pyridine of 0.47 g,

### NMP of 53.68 g, and

toluene of 20 g
are added respectively, and the treatment similar to that in the Example 1 is conducted thereafter, to provide a polyimide powder.

(Measurement of Light Transmission Rate)

Measurement of the light transmission rate was conducted by following process. At first, respective polyimide resin composition solutions with a solid concentration of 15% were prepared by using respective polyimide powders in the Examples 1 to 19 and the Comparative examples 1 to 8. Each of samples for evaluating the light transmission rate was manufactured by applying each of the polyimide resin composition solutions on a quartz glass substrate by the spin coat method, heating it at a temperature of 80° C. for temporary desiccation, then heating it at a temperature of 250° C. for drying, and forming a film of resin to have a thickness of about 1 μm. For each of the samples, a light transmission rate in a wavelength of 400 nm was measured by using a UV-visible spectrophotometer. In the evaluation of the light transmission rate, the film having the light transmission rate not less than 80% is indicated as o, and the film having the light transmission rate less than 80% is indicated as x.

(Measurement of Pretilt Angle)

Measurement of the pretilt angle was conducted by following process. At first, respective polyimide resin composition solutions with a solid concentration of 3% were prepared by using respective polyimide powders in the Examples 1 to 19 and the Comparative examples 1 to 8. Each of uniform polyimide coating films was manufactured by applying each of the polyimide resin composition solutions on a glass substrate provided with ITO (Indium-Tin-Oxide) transparent electrode by the spin coat method under the condition of a spin revolution number of 2500 rpm and a revolution time of 40 seconds, heating it on a hot plate at a temperature of 80° C. for temporary desiccation, then heating it in a constant-temperature bath at a temperature of 250° C. for drying. This coating film was rubbed by a rubbing machine (RM-50) manufactured by EHC Co., Ltd., with use of a roll on which a rayon cloth is wound. The rubbing condition was as follows: a revolution number of a roll is 800 rpm, a travel speed of a stage is 600 mm/min, and a pushing amount of a fiber length is 0.4 mm. Thereafter, the respective substrates were disposed in a state shown in FIG. 1 and a spacer with a thickness of 50 μm is interposed between the substrates to be assembled such that the rubbing directions are opposite to each other. A liquid crystal composition (ZLI-4792 (manufactured by Merck Ltd.)) was injected into a space surrounded by the substrates and the spacer, to provide each of liquid crystal display units. The pretilt angle was measured for each cell by using crystal rotation method. In the evaluation of the pretilt angle, the cell having the pretilt angle of not less than 3° is indicated as o, and the cell having the pretilt angle of less than 3° is indicated as x.

(Measurement of Liquid Crystal Alignment Property)

After the liquid crystal cell for the pretilt angle measurement was manufactured, the liquid crystal alignment property thereof was observed in visual observation under a condition of polarizing plates with crossed nicols (under a condition where polarization axes are perpendicular to each other) on a light box, and the cell having no alignment abnormality is indicated as o, and the cell having much alignment abnormality (disclination) is indicated as x.

Composition of diamine compound and a weight ratio of an aromatic component (%) for each polyimide powder in the Examples 1 to 19 and the Comparative examples 1 to 8 are shown in TABLE 1. In addition, the light transmission rate, pretilt angle and liquid crystal alignment property of the liquid crystal alignment film and the liquid crystal display unit manufactured by using each polyimide powder in the Examples 1 to 19 and the comparative examples 1 to 8 are also shown in TABLE 1.

TABLE 1

| | | | Weight | | | | Liquid |
|---|---|---|---|---|---|---|---|
| | Diamine compound | | ratio of | Mol | Light | | Crystal |
| | Long-chain | Long-chain | aromatic | fraction | Transmission | Pretilt | Alignment |
| | alkyl group | Alkyl group | group | ratio | rate | Angle | Property |
| Example | Non-containing | containing | (%) | *1 | *2 | *3 | *4 |
| Example 1 | DAHM, XyDA | DODB | 7.9 | 1/1 | ∘ | ∘ | ∘ |
| Example 2 | BACA, APB | DPD | 17.7 | 1/1 | ∘ | ∘ | ∘ |
| Example 3 | DMHM, PPD | DOD | 5.9 | 1/1 | ∘ | ∘ | ∘ |
| Example 4 | DAHM, IPDH | DODB | 13.2 | 2/1 | ∘ | ∘ | ∘ |
| Example 5 | DMHM, IPDH | DOD | 5.5 | 2/1 | ∘ | ∘ | ∘ |
| Example 6 | ATU, XyDA | DPD | 5.3 | 1/1 | ∘ | ∘ | ∘ |
| Example 7 | DMHM, XyDA | DOD | 5.8 | 1/1 | ∘ | ∘ | ∘ |
| Example 8 | DMHM, APB | DOD | 15.5 | 1/1 | ∘ | ∘ | ∘ |
| Example 9 | 1,2-cyclohexane- | DODB | 8.3 | 2/1 | ∘ | ∘ | ∘ |
| | diamine, IPDH | | | | | | |
| Example 10 | DMHM | DODB | 5.8 | 1/1 | ∘ | ∘ | ∘ |
| Example 11 | DMHM, PPD | DOD | 8.1 | 2/1 | ∘ | ∘ | ∘ |
| Example 12 | ATU, PPD | DPD | 4.8 | 1/2 | ∘ | ∘ | x |
| Example 13 | DMHM, PPD | DODB | 12.9 | 1/1 | ∘ | ∘ | ∘ |
| Example 14 | DMHM, PPD | DOD | 5.7 | 1/1 | ∘ | ∘ | ∘ |
| Example 15 | DMHM, APB | DOD | 18.9 | 7/6 | ∘ | ∘ | ∘ |
| Example 16 | DMHM, PPD | DOD | 5.9 | 4/3 | ∘ | ∘ | ∘ |
| Example 17 | DMHM, IPDH | DOD | 5.5 | 3/2 | ∘ | ∘ | ∘ |
| Example 18 | DMHM, PPD | DODB | 12.9 | 13/7 | ∘ | ∘ | ∘ |
| Example 19 | DMHM, PPD | DOD | 5.9 | 6/7 | ∘ | ∘ | x |
| Comparative | 3,5-diamino | NONE | 52.8 | 1/0 | x | x | ∘ |
| Example 1 | benzoic acid | | | | | | |
| Comparative | DMHM | NONE | 0 | 0/0 | ∘ | x | ∘ |
| Example 2 | | | | | | | |
| Comparative | DMHM | DOD | 0 | 0/1 | ∘ | x | x |
| Example 3 | | | | | | | |
| Comparative | DMHM 2,2′-bis | NONE | 13.7 | 1/0 | ∘ | x | ∘ |
| Example 4 | {4-(4-aminophen- | | | | | | |
| | oxy)phenyl}hexa- | | | | | | |
| | fluoro propane | | | | | | |
| Comparative | DMHM, | NONE | 21.3 | 1/0 | x | x | ∘ |
| Example 5 | 4,4′-diaminophenyl- | | | | | | |
| | sulfone | | | | | | |
| Comparative | DAHM, APB | DODB | 25.8 | 4/3 | x | ∘ | ∘ |
| Example 6 | | | | | | | |
| Comparative | DAHM, APB | DODB | 24.4 | 16/15 | x | ∘ | ∘ |
| Example 7 | | | | | | | |
| Comparative | DMHM, APB | DODB | 21.2 | 6/7 | x | ∘ | x |
| Example 8 | | | | | | | |

*1: Mol fraction ratio = (mol fraction of the aromatic diamine)/(mol fraction of the long-chain alkyl group-containing diamine)
*2: The light transmission rate of not less than 80% is indicated as ∘, and the light transmission rate of less than 80% is indicated as x.
*3: The pretilt angle of not less than 3° is indicated as ∘, and the pretilt angle of less than 3° is indicated as x.
*4: No alignment abnormality is indicated as ∘, and much alignment abnormality is indicated as x.

As shown in TABLE 1, either film (sample) manufactured by using the respective polyimide powders in the Examples 1 to 19 included the long-chain alkyl group as the diamine compound in the polyimide skeleton. In addition, each of these diamine compounds comprised an aromatic component (PPD in the Examples 3, 11, 12, 13, 14, 16, 18, and 19, IPDH in the Examples 4, 5, 9, and 17, XyDA in the Examples 1, 6, and 7, APB in the Examples 2, 8, and 15, and DODB in the Examples 1, 4, 9, 10, 13, and 18) in a ratio that a weight ratio of the aromatic component relative to a total weight of the polyimide is not more than 20% (4.8 to 18.9%). Therefore, in either film, the light transmission rate was good namely not less than 80%, and the pretilt angle was not less than 3°.

More particularly, the liquid crystal cell manufactured by using each polyimide powder in the Examples 1 to 11 and the Examples 13 to 18, a value of (mol fraction of the aromatic diamine)/(mol fraction of the long-chain alkyl group containing diamine) was not less than 1, and the liquid crystal alignment property was good.

On the contrary, a film (sample) manufactured by using the polyimide powder in the comparative example 2 does not include the long-chain alkyl group as the diamine compound in the polyimide skeleton. In addition, this diamine compound does not include the aromatic component. Therefore, in this film, although the light transmission rate was good namely not less than 80%, the pretilt angle was small namely less than 3°.

The films (sample) manufactured by using the polyimide powder in the comparative examples 1 and 5 do not include the long-chain alkyl group as the diamine compound in the polyimide skeleton. In addition, although these diamine compounds include the aromatic component, the weight of the aromatic component in both films was more than 20% (52.8%, 21.3%). Therefore, in these films, the light transmission rate was less than 80% and the pretilt angle was less than 3°, so that the both characteristics were bad.

In the film (sample) manufactured by using the polyimide powder in the comparative example 4, the weight ratio of the aromatic component in the diamine compound was 13.7%, which was within a stipulated range (not more than 20%), however the film does not include the long-chain alkyl group as the diamine compound in the polyimide skeleton. Therefore, in this film, although the light transmission rate was good namely not less than 80%, the pretilt angle was small namely less than 3°.

Although the film (sample) manufactured by using the polyimide powder in the Comparative example 3 includes the long-chain alkyl group as the diamine compound in the polyimide skeleton, the diamine compound does not include the aromatic component. Therefore, in this film, although the light transmission rate was good namely not less than 80%, the pretilt angle was small namely less than 3°. In addition, the value of (mol fraction of the aromatic diamine)/(mol fraction of the long-chain alkyl group containing diamine) was less than 1, and the liquid crystal alignment property was also bad.

The films (sample) manufactured by using the polyimide powders in the comparative examples 6 and 7 include the long-chain alkyl group as the diamine compound in the polyimide skeleton and the diamine compound therein includes the aromatic component. However, the weight of the aromatic component in both films was more than 20% (25.8%, 24.4%). Therefore, in these films, although the pretilt angle was good namely not less than 3°, the light transmission rate was small namely less than 80%.

The film (sample) manufactured by using the polyimide powder in the comparative example 8 includes the long-chain alkyl group as the diamine compound in the polyimide skeleton and the diamine compound therein include the aromatic component. However, the weight of the aromatic component was more than 20% (21.2%). Therefore, in this film, although the pretilt angle was good namely not less than 3°, the light transmission rate was small namely less than 80%. In addition, the value of (mol fraction of the aromatic diamine)/(mol fraction of the long-chain alkyl group containing diamine) was less than 1, and the liquid crystal alignment property was also bad.

From the above results, it is confirmed that it is necessary to include a long-chain alkyl group as the diamine compound in the polyimide skeleton and comprise an aromatic component not more than 20% relative to a total weight of the polyimide, so as to achieve a polyimide resin composition in that the light transmission rate of not less than 80% is compatible with the pretilt angle of not less than 3°. In addition, it is found that a value of (mol fraction of the long-chain alkyl group containing diamine)/(mol fraction of the aromatic diamine) should be not less than 1, so as to improve the liquid crystal alignment property.

### INDUSTRIAL APPLICABILITY

The liquid crystal display using the polyimide resin composition in the present invention is suitable for the liquid crystal display used as a display unit of various information apparatuses, and in particular, suitable for the display unit having a light source with a high optical output such as the liquid crystal projector in which a high light resistance is required.

Although the invention has been described with respect to the specific embodiments for complete and clear disclosure, the appended claims are not to be thus limited but are to be construed as embodying all modifications and alternative constructions that may occur to one skilled in the art which fairly fall within the basic teaching herein set forth.

1-12. (canceled)

13. A polyimide resin composition composed of an acid dianhydride and a diamine compound, which includes a long-chain alkyl group in a side-chain in its polyimide skeleton, and includes an aromatic component such that a weight ratio of the aromatic component relative to a total weight of a polyimide is not more than 20% (excluding 0%).

14. The polyimide resin composition according to claim 13, wherein the diamine compound includes a long-chain alkyl group in a side-chain.

15. The polyimide resin composition according to claim 13, wherein the acid dianhydride is an aliphatic system acid dianhydride.

16. The polyimide resin composition according to claim 13, wherein the diamine compound includes an aromatic diamine compound and an aliphatic diamine compound, and at least one of the aromatic diamine compound and the aliphatic diamine compound includes a long-chain alkyl group in a side-chain.

17. The polyimide resin composition according to claim 16, wherein a mol fraction of the aromatic diamine compound is not less than a mol fraction of the diamine compound including the long-chain alkyl group in the side-chain.

18. The polyimide resin composition according to claim 16, wherein the diamine compound including the long-chain alkyl group in the side-chain is an aliphatic diamine compound.

19. The polyimide resin composition according to claim 13, wherein a light transmission rate is not less than 80% with respect to a light having a wavelength of 400 to 800 nm when a film composed of the polyimide resin composition has a film thickness of 1 μm.

20. A polyimide resin composition composed of an acid dianhydride and a diamine compound, which has repeating units represented by the formula (I) and includes an aromatic component such that a weight ratio of the aromatic component relative to a total weight of a polyimide is not more than 20% (excluding 0%): 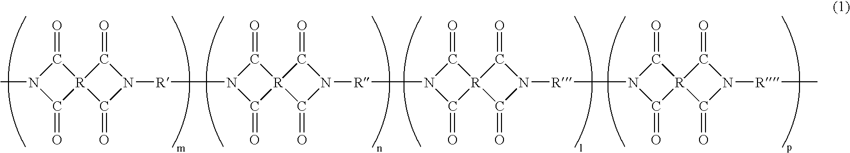
(wherein R represents a tetravalent aliphatic group, and R′, R″, R′″, and R″″ are a divalent long-chain alkyl group non-containing aromatic group, a long-chain alkyl group non-containing aliphatic group, a long-chain alkyl group containing aromatic group, and a long-chain alkyl group containing aliphatic group, respectively. m, n, l, and p represent copolymerization ratios in the polyimide resin, respectively, wherein relationships m+n+l+p=1 and m≧0, n≧0, l≧0, p≧0, m+l>0, n+p>0, and l+p>0 are established).

21. The polyimide resin composition according to claim 20, wherein a mol fraction of the aromatic diamine compound is not less than a mol fraction of a long-chain alkyl group containing diamine in the diamine compound constituting the formula (1).

22. The polyimide resin composition according to claim 21, wherein the long-chain alkyl group containing diamine is an aliphatic diamine compound.

23. The polyimide resin composition according to claim 20, wherein a light transmission rate is not less than 80% with respect to a light having a wavelength of 400 to 800 nm when a film composed of the polyimide resin composition has a film thickness of 1 μm.

24. A liquid crystal alignment film comprising:
a polyimide resin composition composed of an acid dianhydride and a diamine compound, which includes a long-chain alkyl group in a side-chain in its polyimide skeleton, and includes an aromatic component such that a weight ratio of the aromatic component relative to a total weight of a polyimide is not more than 20% (excluding 0%);
wherein a light transmission rate is not less than 80% with respect to a light having a wavelength of 400 to 800 nm when the film has a film thickness of 1 μm.

25. A liquid crystal display unit comprising:
a pair of substrates, at least one of the substrates being transparent;
the liquid crystal alignment films, each of which being formed on opposite faces of the pair of substrates and comprising a polyimide resin composition composed of an acid dianhydride and a diamine compound, which includes a long-chain alkyl group in a side-chain in its polyimide skeleton, and includes an aromatic component such that a weight ratio of the aromatic component relative to a total weight of a polyimide is not more than 20% (excluding 0%), with a light transmission rate of not less than 80% with respect to a light having a wavelength of 400 to 800 nm when the film has a film thickness of 1 μm;
a liquid crystal composition disposed between the liquid crystal alignment films;
wherein a liquid crystal molecular group included in the liquid crystal composition has a pretilt angle of not less than
